(19) United States
(12) Patent Application Publication
(10) Pub. No.: US 2025/0158201 A1
(43) Pub. Date: May 15, 2025

(54) POWER STORAGE DEVICE

(71) Applicant: TOYOTA JIDOSHA KABUSHIKI KAISHA, Toyota-shi (JP)

(72) Inventor: Shingo KOMURA, Nagakute-shi (JP)

(73) Assignee: TOYOTA JIDOSHA KABUSHIKI KAISHA, Toyota-shi (JP)

(21) Appl. No.: 18/896,021

(22) Filed: Sep. 25, 2024

(30) Foreign Application Priority Data
Nov. 15, 2023 (JP) 2023-194290

(51) Int. Cl. H01M 50/258; H01M 50/103; H01M 50/121; H01M 50/209; H01M 50/609

(52) U.S. Cl. CPC H01M 50/258; H01M 50/103; H01M 50/121; H01M 50/209; H01M 50/289; H01M 50/609

(57) ABSTRACT

A power storage device includes a plurality of power storage modules stacked on top of each other. Each power storage module includes an electrode stacked body and a frame body. The frame body has a pair of first frame portions and a pair of second frame portions. The pair of first frame portions include a liquid injection frame portion in which a liquid injection port is formed. At least one of the pair of second frame portions has a second frame portion main body, a protrusion, and a recess having a shape fitted to the protrusion. Parts that overlap with the liquid injection port in an up-down direction, of an upper surface and a lower surface of the liquid injection frame portion, are formed flatly.

### CROSS REFERENCE TO RELATED APPLICATIONS

This nonprovisional application is based on Japanese Patent Application No. 2023-194290 filed on Nov. 15, 2023 with the Japan Patent Office, the entire contents of which are hereby incorporated by reference.

### BACKGROUND OF THE DISCLOSURE

### Field of the Disclosure

The present disclosure relates to a power storage device.

### Description of the Background Art

Japanese National Patent Publication No. 2005-503655 discloses a bipolar battery having a plurality of biplate stacked bodies. Each biplate stacked body has a biplate, a positive electrode provided on one surface of the biplate, a negative electrode provided on the other surface of the biplate, and a frame holding a periphery of the biplate. An upper surface of the frame is provided with a projection formed in an annular shape and a recess formed in an annular shape. In the bipolar battery, the projection in one biplate stacked body is fitted to the recess in a biplate stacked body stacked on the one biplate stacked body.

### SUMMARY OF THE DISCLOSURE

When the frame is provided with a liquid injection port for injecting an electrolyte solution in the bipolar battery described in Japanese National Patent Publication No. 2005-503655, there is a concern that the liquid injection port may interfere with the projection or the recess, and thus there is a limitation in the design of the liquid injection port.

An object of the present disclosure is to provide a power storage device that can suppress positional displacement between power storage modules stacked on top of each other while securing the degree of freedom of design of a liquid injection port.

A power storage device according to one aspect of the present disclosure includes a plurality of power storage modules stacked on top of each other, each of the plurality of power storage modules including an electrode stacked body including a plurality of electrodes stacked on top of each other, and a frame body having a shape that surrounds a periphery of the electrode stacked body and holding an edge portion of the electrode stacked body, the frame body having a pair of first frame portions facing each other and holding a portion of the edge portion of the electrode stacked body, and a pair of second frame portions extending in a direction intersecting the first frame portions and facing each other, and holding a remaining portion of the edge portion of the electrode stacked body, the pair of first frame portions including a liquid injection frame portion in which a liquid injection port for supplying an electrolyte solution to the electrode stacked body is formed, at least one of the pair of second frame portions having a second frame portion main body coupling the pair of first frame portions and having an upper surface and a lower surface, at least one protrusion provided in either one surface of the upper surface and the lower surface of the second frame portion main body, and at least one recess provided in the other surface of the upper surface and the lower surface of the second frame portion main body and having a shape fitted to the protrusion, the liquid injection frame portion having an upper surface and a lower surface, and parts that overlap with the liquid injection port in an up-down direction, of the upper surface and the lower surface, are formed flatly.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view schematically showing a power storage device in one embodiment of the present disclosure.

FIG. 2 is a plan view of the power storage device.

FIG. 3 is a cross sectional view schematically showing bipolar electrodes.

FIG. 4 is a cross sectional view schematically showing monopolar electrodes.

FIG. 5 is a cross sectional view taken along a line V-V in FIG. 2.

FIG. 6 is a cross sectional view schematically showing a variation of arrangement of protrusions and recesses.

FIG. 7 is a cross sectional view schematically showing a variation of the protrusions.

FIG. 8 is a cross sectional view schematically showing a variation of the protrusions.

FIG. 9 is a perspective view schematically showing a variation of the protrusion.

FIG. 10 is a cross sectional view schematically showing the variation of the protrusion.

FIG. 11 is a perspective view schematically showing a variation of the power storage device.

FIG. 12 is a perspective view schematically showing a variation of the power storage device.

FIG. 13 is a perspective view schematically showing a variation of the power storage device.

### DESCRIPTION OF THE PREFERRED EMBODIMENTS

An embodiment of the present disclosure will be described with reference to the drawings. It should be noted that, in the drawings referred to below, identical or corresponding members will be designated by the same numerals.

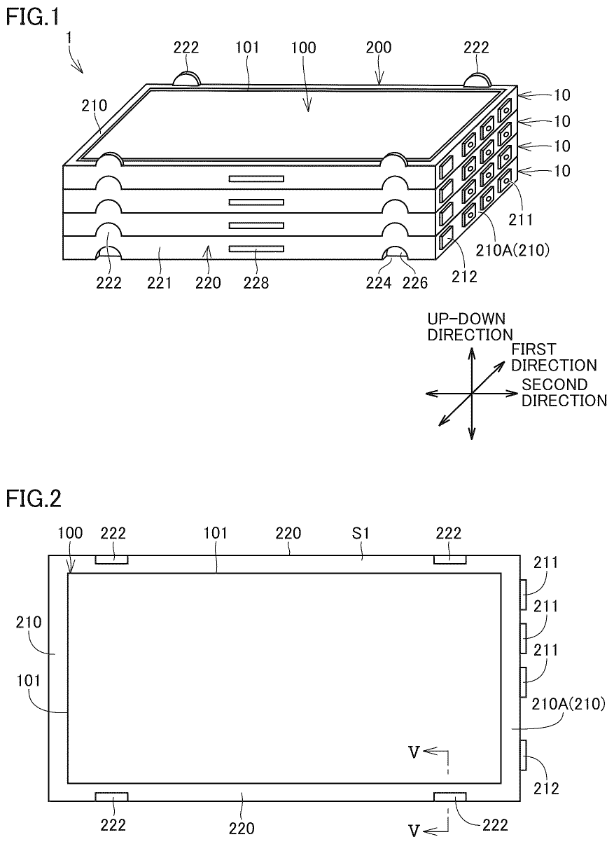

FIG. 1 is a perspective view schematically showing a power storage device in one embodiment of the present disclosure. FIG. 2 is a plan view of the power storage device.

As shown in FIGS. 1 and 2, a power storage device 1 includes a plurality of power storage modules 10. The plurality of power storage modules 10 are stacked on top of each other. In the present embodiment, the plurality of power storage modules 10 include four power storage modules 10. However, the number of power storage modules 10 is not limited to four. As shown in FIG. 2, each power storage module 10 is formed to have a rectangular outer shape in a plan view. Each power storage module 10 includes an electrode stacked body 100 and a frame body 200.

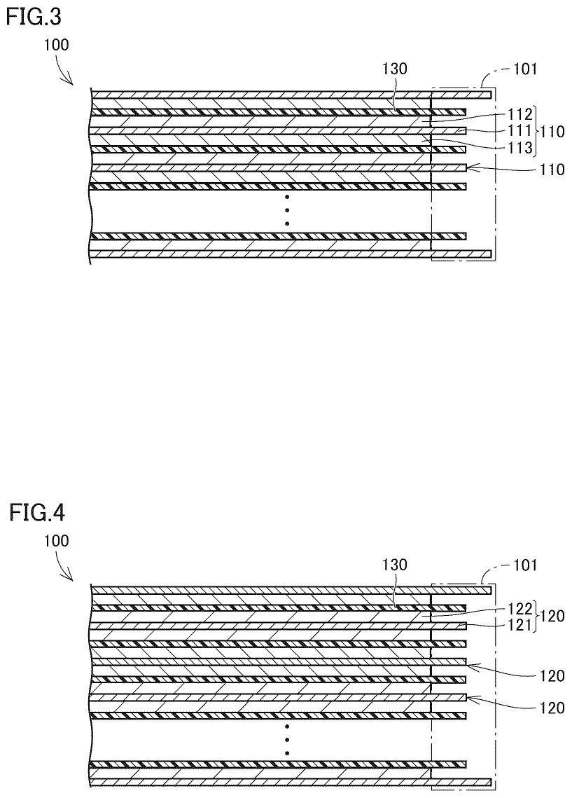

Electrode stacked body 100 includes a plurality of electrodes stacked on top of each other. Electrode stacked body 100 has an edge portion 101. Each electrode may be constituted by a bipolar electrode 110 shown in FIG. 3. Bipolar electrode 110 has a current collecting foil 111, a positive electrode active material layer 112 provided on one surface of current collecting foil 111, and a negative electrode active material layer 113 provided on the other surface of current collecting foil 111. In this case, electrode stacked body 100 is constituted by alternately stacking bipolar electrode 110 and a separator 130.

Alternatively, each electrode may be constituted by a monopolar electrode 120 shown in FIG. 4. Positive or negative monopolar electrode 120 has a current collecting foil 121, and an active material layer 122 provided on the current collecting foil. In this case, electrode stacked body 100 is constituted by stacking positive monopolar electrode 120 and negative monopolar electrode 120 with separator 130 being interposed therebetween.

Frame body 200 has a shape that surrounds a periphery of electrode stacked body 100. Frame body 200 holds edge portion 101 of electrode stacked body 100. Frame body 200 is made of an insulating material (such as a resin). Preferably, frame body 200 is made of a thermoplastic resin. Frame body 200 seals edge portion 101 of electrode stacked body 100. Frame body 200 has a function of preventing leakage of an electrolyte solution from electrode stacked body 100 and moisture ingress into electrode stacked body 100 from outside, and a function of maintaining a spacing between the electrodes. Frame body 200 is formed in the shape of a quadrangular tube.

Frame body 200 has a pair of first frame portions 210 and a pair of second frame portions 220.

The pair of first frame portions 210 face each other. The pair of first frame portions 210 hold a portion of edge portion 101 of electrode stacked body 100. Each first frame portion 210 has a shape extending in a first direction (see FIG. 1).

The pair of first frame portions 210 include a liquid injection frame portion 210A. In liquid injection frame portion 210A, a plurality of liquid injection ports 211 for supplying the electrolyte solution to electrode stacked body 100 are formed. The plurality of liquid injection ports 211 are provided along the first direction, with a spacing therebetween. It should be noted that, although three liquid injection ports 211 are shown in FIGS. 1 and 2 for convenience, the number of liquid injection ports 211 is not limited to three. Liquid injection frame portion 210A has an upper surface and a lower surface, and ranges that overlap with liquid injection port 211 in an up-down direction, of the upper surface and the lower surface, are formed flatly.

Liquid injection frame portion 210A may be provided with a voltage detection terminal 212. Voltage detection terminal 212 is electrically connected to the electrodes of electrode stacked body 100. Voltage detection terminal 212 may be provided at an end portion of liquid injection frame portion 210A in the first direction.

The pair of second frame portions 220 extend in a direction intersecting first frame portions 210, and face each other. In the present embodiment, each second frame portion 220 extends in a second direction (see FIG. 1) orthogonal to first frame portions 210. The length of second frame portion 220 in the second direction is larger than the length of first frame portion 210 in the first direction. The pair of second frame portions 220 hold a remaining portion of edge portion 101 of electrode stacked body 100.

At least one of the pair of second frame portions 220 has a second frame portion main body 221, at least one protrusion 222, at least one recess 224, and at least one blocking wall 226. In the present embodiment, as shown in FIGS. 1 and 2, each second frame portion 220 has two protrusions 222, two recesses 224, and two blocking walls 226. However, the number of protrusions 222, the number of recesses 224, and the number of blocking walls 226 are each not limited to two.

Each second frame portion main body 221 couples the pair of first frame portions 210. As shown in FIG. 5, each second frame portion 220 has an upper surface S1 and a lower surface S2.

Two protrusions 222 are provided at positions spaced from each other in the second direction. Each protrusion 222 is provided in either one surface of upper surface S1 and lower surface S2 of second frame portion main body 221. In the present embodiment, protrusion 222 is provided in upper surface S1 of second frame portion main body 221. Preferably, a height of protrusion 222 from upper surface S1 is set to more than or equal to 5% and less than or equal to 75% of a height of second frame portion main body 221 (a dimension between upper surface S1 and lower surface S2).

Protrusion 222 has a shape in which a cross sectional area of protrusion 222 in an orthogonal plane orthogonal to the up-down direction gradually decreases with increase in distance from upper surface S1 of second frame portion main body 221. In the present embodiment, protrusion 222 has a shape curved to protrude upward. Specifically, protrusion 222 is formed in the shape of a semicircular plate having a substantially uniform thickness in the first direction. Protrusion 222 may be formed in the shape of a hemisphere.

Each recess 224 is provided at a position corresponding to each protrusion 222 in the up-down direction. Each recess 224 is provided in the other surface of upper surface S1 and lower surface S2 of second frame portion main body 221. In the present embodiment, recess 224 is provided in lower surface S2 of second frame portion main body 221. Recess 224 has a shape fitted to protrusion 222. Recess 224 has a shape recessed upward from lower surface S2. In the present embodiment, recess 224 is opened to an outside in a direction connecting the pair of second frame portions 220 (the first direction).

Blocking wall 226 is formed inside recess 224 in the direction connecting the pair of second frame portions 220. Blocking wall 226 blocks electrode stacked body 100 from a space outside second frame portion 220.

As shown in FIG. 5, blocking wall 226 may have a guide surface 226a. Guide surface 226a is formed at a lower end portion of blocking wall 226. Guide surface 226a guides protrusion 222 toward recess 224. In more detail, when another power storage module 10 is stacked on one power storage module 10 as indicated by an arrow in FIG. 5, guide surface 226a in the other power storage module 10 guides protrusion 222 in the one power storage module 10 toward recess 224 in the other power storage module 10.

It should be noted that blocking wall 226 may be omitted from second frame portion 220, and recess 224 may penetrate in a thickness direction of second frame portion main body 221 (the first direction).

As shown in FIG. 1, second frame portion 220 may have a step portion 228. Step portion 228 may protrude from an outer side surface of second frame portion main body 221, or may be recessed from the outer side surface of second frame portion main body 221. Step portion 228 may be used to be held by fingers of an operator, a hook of a suspending machine, or the like, when power storage module 10 is removed.

As described above, in power storage device 1 in the present embodiment, since protrusion 222 of second frame portion 220 in one power storage module 10 is fitted to recess 224 of second frame portion 220 in power storage module 10 adjacent to the one power storage module 10, the plurality of power storage modules 10 are stacked while being effectively positioned with respect to each other. Further, since second frame portion 220, which is different from first frame portion 210 in which liquid injection port 211 is formed, has protrusion 222 and recess 224, both of the degree of freedom of design of liquid injection port 211 and the degree of freedom of design of protrusion 222 and recess 224 are secured.

In addition, since power storage modules 10 adjacent to each other are positioned with respect to each other by protrusion 222 and recess 224, even when the plurality of power storage modules 10 are restrained by restriction plates from both sides in a stacking direction using a relatively small restriction load (for example, 40 kN), positional displacement between power storage modules 10, which occurs when a collision under prescribed conditions is inputted thereto, is suppressed to less than or equal to 10 mm.

In the following, variations in the embodiment described above will be described.

### First Variation

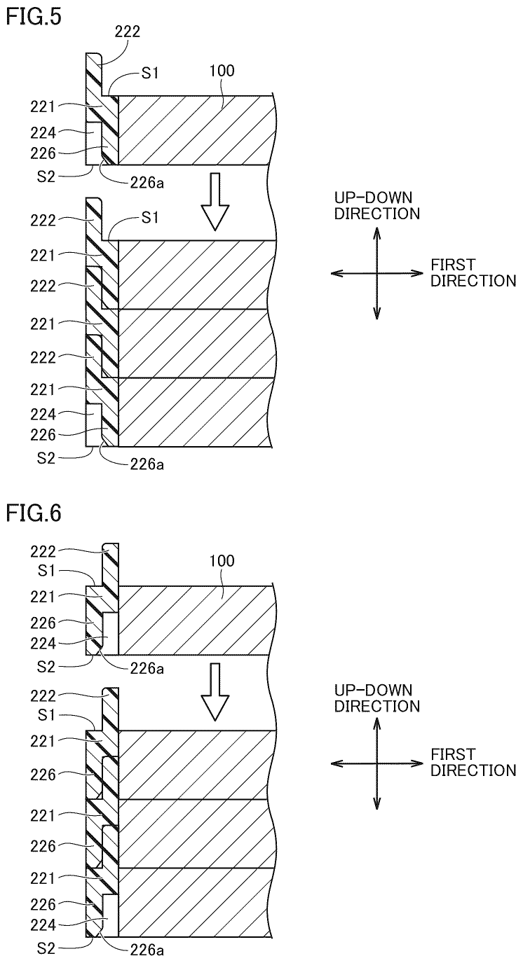

As shown in FIG. 6, recess 224 is opened to an inside in the direction connecting the pair of second frame portions 220 (the first direction). Blocking wall 226 is formed outside recess 224 in the direction connecting the pair of second frame portions 220.

### Second Variation

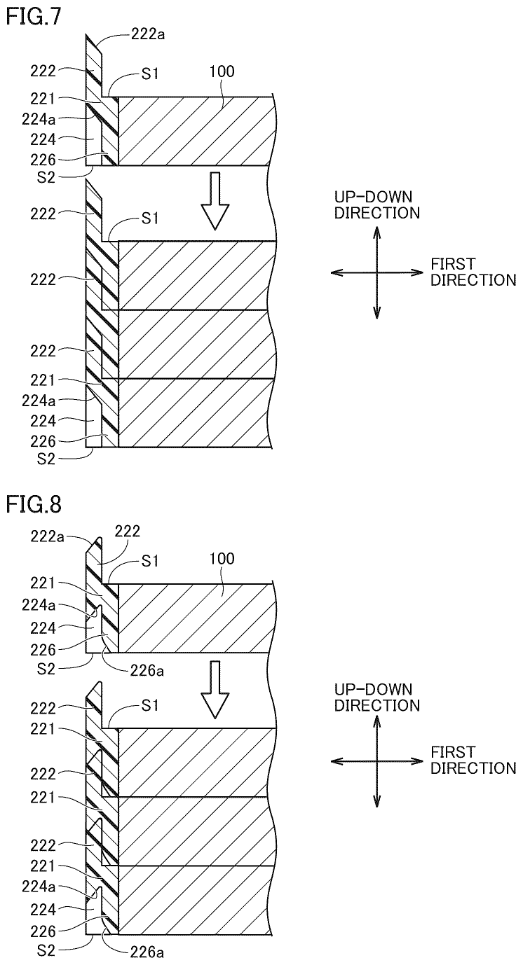

As shown in FIG. 7, protrusion 222 has a top surface 222a. Top surface 222a is inclined to be gradually closer to upper surface S1 of second frame portion main body 221, toward the inside in the direction connecting the pair of second frame portions 220 (the first direction). Recess 224 has an abutment surface 224a that abuts on top surface 222a. Abutment surface 224a is inclined to be gradually closer to lower surface S2 of second frame portion main body 221, toward the inside in the first direction.

### Third Variation

As shown in FIG. 8, top surface 222a of protrusion 222 is inclined to be gradually away from upper surface S1 of second frame portion main body 221, toward the inside in the direction connecting the pair of second frame portions 220 (the first direction). Abutment surface 224a of recess 224 is inclined to be gradually closer to upper surface S1 of second frame portion main body 221, toward the inside in the first direction.

### Fourth Variation

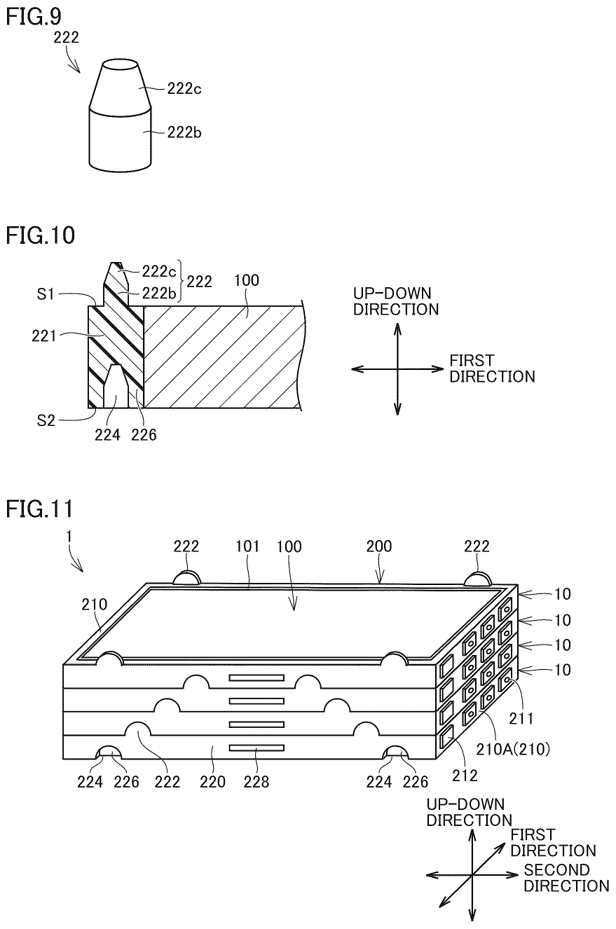

As shown in FIGS. 9 and 10, protrusion 222 has a base portion 222b and a tip portion 222c.

Base portion 222b rises from upper surface S1 of second frame portion main body 221. Base portion 222b has a shape in which a cross sectional area of base portion 222b in the orthogonal plane orthogonal to the up-down direction is uniform in the up-down direction. In the example shown in FIG. 9, base portion 222b is formed in the shape of a circular column. However, base portion 222b may be formed in the shape of an elliptic column, a polygonal column (such as a quadrangular column), or the like.

Tip portion 222c is provided on base portion 222b. That is, base portion 222b couples upper surface S1 of second frame portion main body 221 and tip portion 222c. Tip portion 222c has a shape in which a cross sectional area of tip portion 222c in the orthogonal plane orthogonal to the up-down direction gradually decreases with increase in distance from upper surface S1 of second frame portion main body 221. In the example shown in FIG. 9, tip portion 222c is formed in the shape of a truncated cone. However, tip portion 222c may be formed in the shape of a truncated elliptical cone, a truncated pyramid, or the like.

### Fifth Variation

As shown in FIG. 11, positions of protrusions 222 and recesses 224 in power storage modules 10 are offset from each other in a direction connecting the pair of first frame portions 210 (the second direction). For example, protrusion 222 in one power storage module 10 may be provided at a position offset from protrusion 222 in power storage module 10 adjacent to the one power storage module 10, in the direction connecting the pair of first frame portions 210 (the second direction).

### Sixth Variation

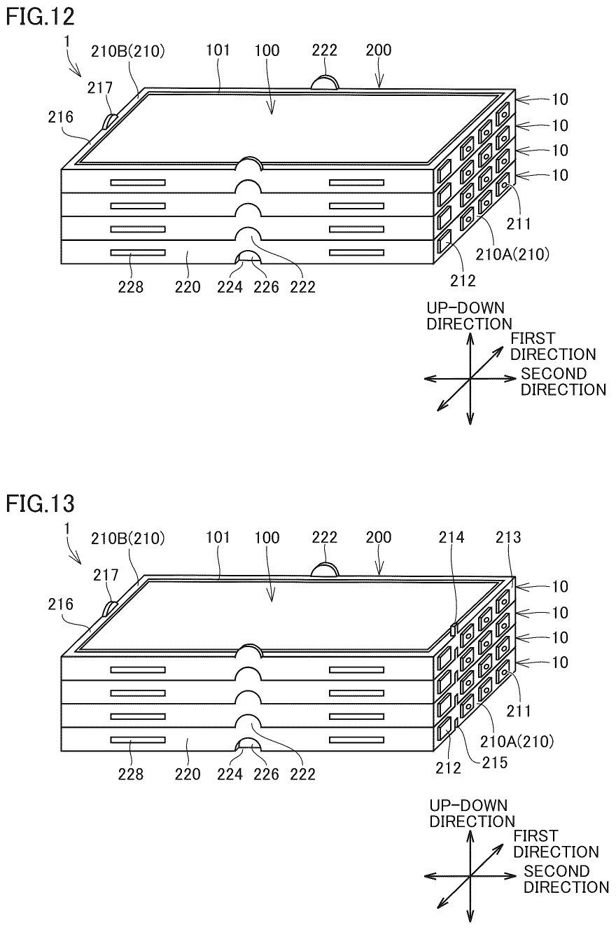

As shown in FIG. 12, the pair of first frame portions 210 in each power storage module 10 include a facing frame portion 210B that faces liquid injection frame portion 210A. Facing frame portion 210B has a facing frame portion main body 216 coupling the pair of second frame portions 220, at least one protrusion 217 formed in facing frame portion main body 216, and at least one recess (not shown) formed in facing frame portion main body 216. Shapes of protrusion 217 and the recess in facing frame portion 210B may be the same as or different from the shapes of protrusion 222 and recess 224 in second frame portion 220.

### Seventh Variation

As shown in FIG. 13, liquid injection frame portion 210A has a liquid injection frame portion main body 213, at least one protrusion 214 formed in liquid injection frame portion main body 213, and at least one recess 215 formed in liquid injection frame portion main body 213. Protrusion 214 in liquid injection frame portion 210A is formed at a part that does not overlap with each liquid injection port 211 in the up-down direction, of an upper surface of liquid injection frame portion main body 213. Recess 215 in liquid injection frame portion 210A is formed at a part that does not overlap with each liquid injection port 211 in the up-down direction, of a lower surface of liquid injection frame portion main body 213. In the example shown in FIG. 13, the pair of first frame portions 210 each have protrusion 214, 217 and a recess. Further, when at least one of the pair of first frame portions 210 has a protrusion and a recess, protrusion 222 and recess 224 in one second frame portion 220 of the pair of second frame portions 220 may be omitted, or protrusions 222 and recesses 224 of both of the pair of second frame portions 220 may be omitted.

It is understood by a person skilled in the art that the illustrative embodiment and examples described above are specific examples of the following aspects.

### [Aspect 1]

A power storage device comprising:
a plurality of power storage modules stacked on top of each other,
each of the plurality of power storage modules including
   an electrode stacked body including a plurality of electrodes stacked on top of each other, and
   a frame body having a shape that surrounds a periphery of the electrode stacked body and holding an edge portion of the electrode stacked body,
the frame body having
   a pair of first frame portions facing each other and holding a portion of the edge portion of the electrode stacked body, and
   a pair of second frame portions extending in a direction intersecting the first frame portions and facing each other, and holding a remaining portion of the edge portion of the electrode stacked body,
one of the pair of first frame portions including a liquid injection frame portion in which a liquid injection port for supplying an electrolyte solution to the electrode stacked body is formed,
at least one of the pair of second frame portions having
   a second frame portion main body coupling the pair of first frame portions and having an upper surface and a lower surface,
   at least one protrusion provided in either one surface of the upper surface and the lower surface of the second frame portion main body, and
   at least one recess provided in the other surface of the upper surface and the lower surface of the second frame portion main body and having a shape fitted to the protrusion,
the liquid injection frame portion having an upper surface and a lower surface, and parts that overlap with the liquid injection port in an up-down direction, of the upper surface and the lower surface, are formed flatly.

In this power storage device, since the protrusion of the second frame portion in one power storage module is fitted to the recess of the second frame portion in a power storage module adjacent to the one power storage module, positional displacement between the power storage modules stacked on top of each other is suppressed. Further, since the second frame portion, which is different from the liquid injection frame portion in which the liquid injection port is formed, has the protrusion and the recess, and the parts that overlap with the liquid injection port in the up-down direction, of the upper surface and the lower surface of the liquid injection frame portion, are formed flatly, both of the degree of freedom of design of the liquid injection port and the degree of freedom of design of the protrusion and the recess are secured.

### [Aspect 2]

The power storage device according to aspect 1, wherein
the at least one protrusion includes a tip portion, and
the tip portion has a shape in which a cross sectional area of the tip portion in an orthogonal plane orthogonal to the up-down direction gradually decreases with increase in distance from the one surface of the second frame portion main body.

In this aspect, since the power storage module stacked on the one power storage module can be easily removed from the one power storage module, maintenance of the power storage device and replacement of the power storage module become easier.

### [Aspect 3]

The power storage device according to aspect 2, wherein
the at least one protrusion further includes a base portion coupling the one surface of the second frame portion main body and the tip portion, and
the base portion has a shape in which a cross sectional area of the base portion in the orthogonal plane is uniform in the up-down direction.

### [Aspect 4]

The power storage device according to aspect 2 or 3, wherein
the tip portion has a top surface,
the top surface is inclined to be gradually away from or closer to the one surface, toward an inside in a direction connecting the pair of second frame portions, and
the recess has an abutment surface that abuts on the top surface.

In this aspect, since the top surface of the tip portion in the one power storage module abuts on the abutment surface of the recess in the power storage module adjacent to the one power storage module, positional displacement of the power storage module adjacent to the one power storage module, with respect to the one power storage module, in the direction connecting the pair of second frame portions is effectively suppressed.

### [Aspect 5]

The power storage device according to any one of aspects 1 to 4, wherein
the recess is opened to an outside in a direction connecting the pair of second frame portions, and
the second frame portion main body includes a blocking wall formed inside the recess in the direction connecting the pair of second frame portions, to block the electrode stacked body from a space outside the second frame portion.

In this aspect, positioning of a pair of power storage modules adjacent to each other and securing of sealing properties for the electrode stacked body are both achieved.

### [Aspect 6]

The power storage device according to any one of aspects 1 to 5, wherein the protrusion of one power storage module of the plurality of power storage modules is provided at a position offset from the protrusion of a power storage module adjacent to the one power storage module, of the plurality of power storage modules, in a direction connecting the pair of first frame portions.

### [Aspect 7]

The power storage device according to any one of aspects 1 to 6, wherein
the pair of first frame portions include a facing frame portion that faces the liquid injection frame portion, and
the facing frame portion has
   a facing frame portion main body coupling the pair of second frame portions and having an upper surface and a lower surface,
   at least one protrusion provided in either one surface of the upper surface and the lower surface of the facing frame portion main body, and
   at least one recess provided in the other surface of the upper surface and the lower surface of the facing frame portion main body and having a shape fitted to the protrusion.

### [Aspect 8]

The power storage device according to any one of aspects 1 to 7, wherein
the liquid injection frame portion has
   a liquid injection frame portion main body including the upper surface, the lower surface, and the liquid injection port,
   at least one protrusion provided at a part that does not overlap with the liquid injection port in the up-down direction, of either one surface of the upper surface and the lower surface of the liquid injection frame portion main body, and
   at least one recess provided at a part that does not overlap with the liquid injection port in the up-down direction, of the other surface of the upper surface and the lower surface of the liquid injection frame portion main body, and having a shape fitted to the protrusion.

### [Aspect 9]

The power storage device according to any one of aspects 1 to 8, wherein a height of the protrusion from the upper surface of the second frame portion main body is set to more than or equal to 5% and less than or equal to 75% of a dimension between the upper surface and the lower surface in the second frame portion main body.

[Aspect 10] The power storage device according to any one of aspects 1 to 9, wherein the frame body is made of a thermoplastic resin.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage device comprising:
a plurality of power storage modules stacked on top of each other,
each of the plurality of power storage modules including
an electrode stacked body including a plurality of electrodes stacked on top of each other, and
a frame body having a shape that surrounds a periphery of the electrode stacked body and holding an edge portion of the electrode stacked body,
the frame body having
a pair of first frame portions facing each other and holding a portion of the edge portion of the electrode stacked body, and
a pair of second frame portions extending in a direction intersecting the first frame portions and facing each other, and holding a remaining portion of the edge portion of the electrode stacked body,
the pair of first frame portions including a liquid injection frame portion in which a liquid injection port for supplying an electrolyte solution to the electrode stacked body is formed,
at least one of the pair of second frame portions having
a second frame portion main body coupling the pair of first frame portions and having an upper surface and a lower surface,
at least one protrusion provided in either one surface of the upper surface and the lower surface of the second frame portion main body, and
at least one recess provided in the other surface of the upper surface and the lower surface of the second frame portion main body and having a shape fitted to the protrusion,
the liquid injection frame portion having an upper surface and a lower surface, and parts that overlap with the liquid injection port in an up-down direction, of the upper surface and the lower surface, are formed flatly.

2. The power storage device according to claim 1, wherein
the at least one protrusion includes a tip portion, and
the tip portion has a shape in which a cross sectional area of the tip portion in an orthogonal plane orthogonal to the up-down direction gradually decreases with increase in distance from the one surface of the second frame portion main body.

3. The power storage device according to claim 2, wherein
the at least one protrusion further includes a base portion coupling the one surface of the second frame portion main body and the tip portion, and
the base portion has a shape in which a cross sectional area of the base portion in the orthogonal plane is uniform in the up-down direction.

4. The power storage device according to claim 2, wherein
the tip portion has a top surface,
the top surface is inclined to be gradually away from or closer to the one surface, toward an inside in a direction connecting the pair of second frame portions, and
the recess has an abutment surface that abuts on the top surface.

5. The power storage device according to claim 1, wherein
the recess is opened to an outside in a direction connecting the pair of second frame portions, and
the second frame portion main body includes a blocking wall formed inside the recess in the direction connecting the pair of second frame portions, to block the electrode stacked body from a space outside the second frame portion.

6. The power storage device according to claim 1, wherein the protrusion of one power storage module of the plurality of power storage modules is provided at a position offset from the protrusion of a power storage module adjacent to the one power storage module, of the plurality of power storage modules, in a direction connecting the pair of first frame portions.

7. The power storage device according to claim 1, wherein
the pair of first frame portions include a facing frame portion that faces the liquid injection frame portion, and
the facing frame portion has
a facing frame portion main body coupling the pair of second frame portions and having an upper surface and a lower surface,
at least one protrusion provided in either one surface of the upper surface and the lower surface of the facing frame portion main body, and
at least one recess provided in the other surface of the upper surface and the lower surface of the facing frame portion main body and having a shape fitted to the protrusion.

8. The power storage device according to claim 1, wherein
the liquid injection frame portion has
a liquid injection frame portion main body including the upper surface, the lower surface, and the liquid injection port,
at least one protrusion provided at a part that does not overlap with the liquid injection port in the up-down direction, of either one surface of the upper surface and the lower surface of the liquid injection frame portion main body, and
at least one recess provided at a part that does not overlap with the liquid injection port in the up-down direction, of the other surface of the upper surface and the lower surface of the liquid injection frame portion main body, and having a shape fitted to the protrusion.

9. The power storage device according to claim 1, wherein a height of the protrusion from the upper surface of the second frame portion main body is set to more than or equal to 5% and less than or equal to 75% of a dimension between the upper surface and the lower surface in the second frame portion main body.

10. The power storage device according to claim 1, wherein the frame body is made of a thermoplastic resin.
